(19) United States
(12) Patent Application Publication
(10) Pub. No.: US 2008/0291124 A1
(43) Pub. Date: Nov. 27, 2008

(54) Soft display system

(76) Inventor: Hsien-Chung Chou, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/819,005

(22) Filed: Jun. 25, 2007

(30) Foreign Application Priority Data
May 23, 2007 (TW) 096208412

(51) Int. Cl. G09G 3/20

(52) U.S. Cl. 345/55

(57) ABSTRACT

A soft display system including: a soft display panel composed of a transparent substrate layer, a soft circuit layer and a display layer; a controller having a signal transmission device connected to the soft circuit layer; an input control device for making the soft circuit layer of the soft display panel generate signals corresponding characters or drawings; and a computer equipment having a computer application interface connected to the signal transmission device. The signals generated by the soft circuit layer are processed by the computer equipment. Then, by means of the conversion of the computer application interface, via the signal transmission device, the signals are output to the soft circuit layer. The images of the characters or drawings are shown on the display layer of the soft display panel.

### BACKGROUND OF THE INVENTION

1. Field of the Invention

The present invention is related to a soft display system which includes a soft display panel as a display unit. The soft display panel can be rolled and easily stored.

2. Description of the Prior Art

The current electronic whiteboards are widely used for demonstration instead of the conventional whiteboards. The market occupation rate of the electronic whiteboards is greatly increased. However, the display panel of such electronic whiteboard is quite heavy. Therefore, structurally, it is necessary to frame the display panel with a rigid frame or fix the display panel on a wall. In general, the weight of the display panel of the conventional electronic whiteboard is about 30-50 kilograms. Therefore, it is quite inconvenient to install the electronic whiteboard. Moreover, in case the electronic whiteboard is not firmly mounted or after a long period of use, the electronic whiteboard tends to loosen and fall off from the wall to hurt a user or other people.

In addition, it is impossible for a user to carry the heavy electronic whiteboard with him/her. Therefore, each application site necessitates a set of electronic whiteboard which is fixedly mounted. Consequently, the cost for the equipment and installation is very high so that the electronic whiteboards still cannot be popularly used.

### SUMMARY OF THE INVENTION

It is therefore a primary object of the present invention to provide a soft display system including: a soft display panel composed of a transparent substrate layer, a soft circuit layer and a display layer; a controller having a signal transmission device connected to the soft circuit layer; an input control device for making the soft circuit layer of the soft display panel generate signals corresponding characters or drawings; and a computer equipment having a computer application interface connected to the signal transmission device. When a user uses the input control device such as an electronic pen, a wireless handwriting board, etc. to write characters or draft drawings, the signals corresponding to the characters or drawings are generated and processed by the computer equipment. By means of the conversion of the computer application interface, via the signal transmission device, the signals are output to the soft circuit layer. The images of the characters or drawings are shown on the display layer of the soft display panel. After used, the user can separate the soft display panel from the controller and roll the soft display panel to store the same in a containing barrel. Accordingly, the user can easily carry the soft display system with him/her and conveniently use the same.

The soft display system of the present invention has the following advantages:

1. After used, the soft display panel of the present invention can be rolled and stored in a containing barrel. Therefore, the user can easily carry the present invention with him/her.

2. The soft display system of the present invention is lightweight.

3. The soft display panel of the present invention can be easily mounted without expertise. The soft display panel can be stretched and hung on a wall and readily used.

The present invention can be best understood through the following description and accompanying drawings wherein:

### BRIEF DESCRIPTION OF THE DRAWINGS

FIG. 1 is an exploded view of the present invention;

FIG. 2 is a connected view of the present invention, showing the use thereof;

FIG. 3 is a sectional view of the soft display panel of the present invention;

FIG. 4 is a perspective view showing that the soft display panel of the present invention is rolled to be stored in a containing barrel; and

FIG. 5 is a block flow chart of the operation of the present invention.

### DETAILED DESCRIPTION OF THE PREFERRED EMBODIMENTS

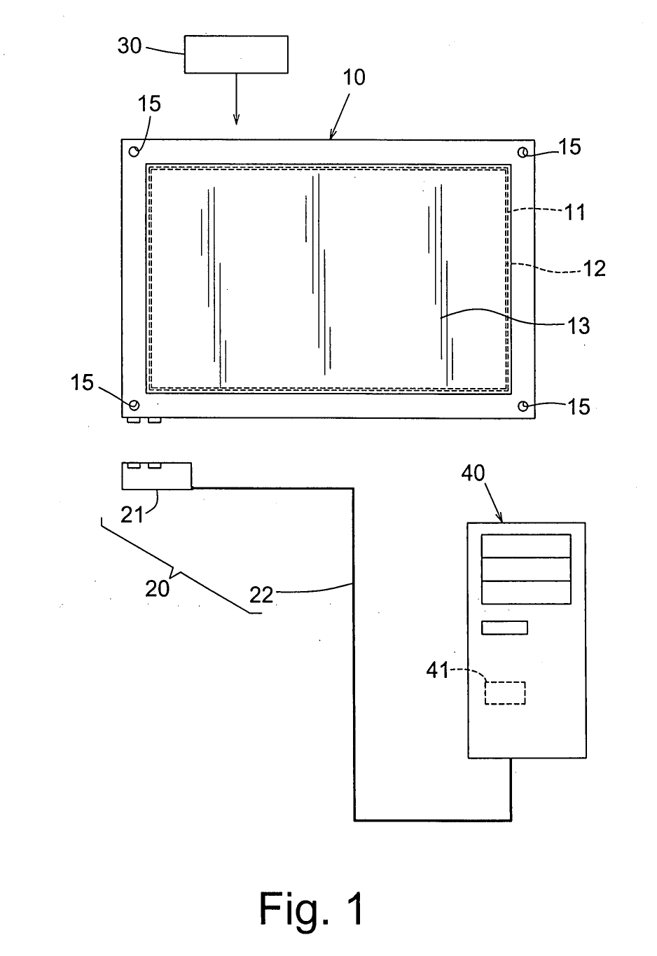

Please refer to FIGS. 1 to 5. The soft display system of the present invention includes a soft display panel 1 composed of a transparent substrate layer 11, a soft circuit layer 12 and a display layer 13. The soft display system of the present invention further includes a controller 20 having a signal transmission device 21 connected to the soft circuit layer 12. The soft display system of the present invention further includes an input control device 30 for generating signals corresponding to characters and drawings. The soft display system of the present invention further includes a computer equipment 40 having a computer application interface 41 connected to the signal transmission device 21. Accordingly, when a user uses the input control device 30 such as an electronic pen, a wireless handwriting board, etc. to write characters or draft drawings, the signals corresponding to the characters or drawings are generated and processed by the computer equipment 40. By means of the conversion of the computer application interface 41, via the signal transmission device 21, the signals are output to the soft circuit layer 12. The images of the characters or drawings are shown on the display layer 13 of the soft display panel 10. Alternatively, an external computer equipment 40 can directly output a signal which is converted by the computer application interface 41. The signal transmission device 21 outputs the signal to the soft circuit layer 12. The images of the characters or drawings are shown on the display layer 13 of the soft display panel 10. Therefore, the input control device 30 is omissible.

Referring to FIG. 3, the soft display panel 10 of the present invention further has a protective layer 14 overlaid on outer side of the display layer 13 to prevent the display layer 13 from being scraped and thrust by alien article.

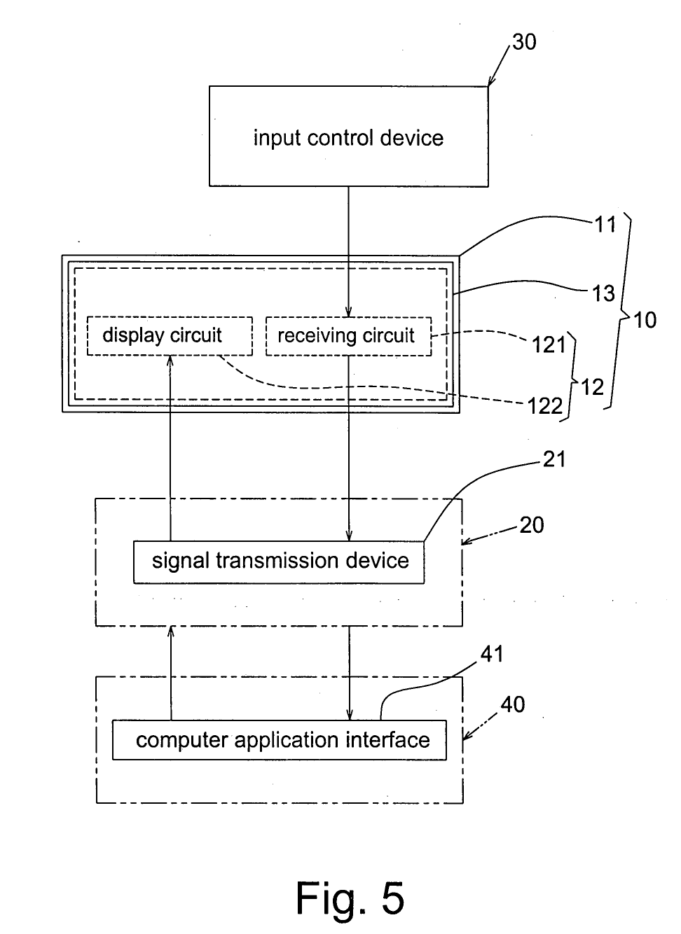

Referring to FIGS. 3 and 5, the soft circuit layer 12 of the soft display panel 10 includes a receiving circuit 121 and a display circuit 122. The receiving circuit 121 serves to responsively receive the signals generated by the input control device 30. The display circuit 122 serves to correspondingly show the images on the display layer 13, which images correspond to the signals transmitted from the signal transmission device 21.

In the soft display system of the present invention, the receiving circuit 121 of the soft display panel 10 can be a touch control receiving circuit. When a user uses the input control device 30 such as an electronic pen or a finger of the user to write characters or draft drawings on the display layer 13 or on the protective layer 14, the receiving circuit 121 of the soft circuit layer 12 generates a signal. The signal is transmitted to the computer equipment 40 for processing by the signal transmission device 21 which is connected with the receiving circuit 121. The processed signal via the computer application interface 41 is then output by the signal transmission device 21 to the display circuit 122 of the soft circuit layer 12. Accordingly, the images correspond to the characters or drawings written by the user are shown on the display layer 13 of the soft display panel 10.

In the soft display system of the present invention, the receiving circuit 121 of the soft circuit layer 12 can be a wireless receiving circuit for correspondingly receiving the wireless signals sent from the input control device 30 such as a wireless handwriting board.

In the soft display system of the present invention, the soft display panel 10 is equipped with hanging sections 15, whereby the soft display panel 10 can be hung on a wall. Alternatively, multiple fixing devices 16 can be first attached to or fixed on a wall face or a glass face and then the hanging sections 15 of the soft display panel 10 are hooked on the hanging hooks 161 of the fixing devices 16. Under such circumstance, the soft display panel 10 can be stretched. The fixing devices 16 pertain to prior art and are not included in the scope of the present invention. The type and structure of the fixing devices 16 are not limited to any specific pattern.

The hanging sections 15 of the soft display panel 10 can be through holes or hanging hooks. Alternatively, the soft display panel 10 can be directly equipped with the fixing devices 16. This is not limited.

In the soft display system of the present invention, the signal transmission device 21 of the controller 20 can be connected to the computer equipment 40 via a signal transmission cable 22. Alternatively, the signal transmission device 21 can be bi-directionally connected to the computer equipment 40 via a wireless element.

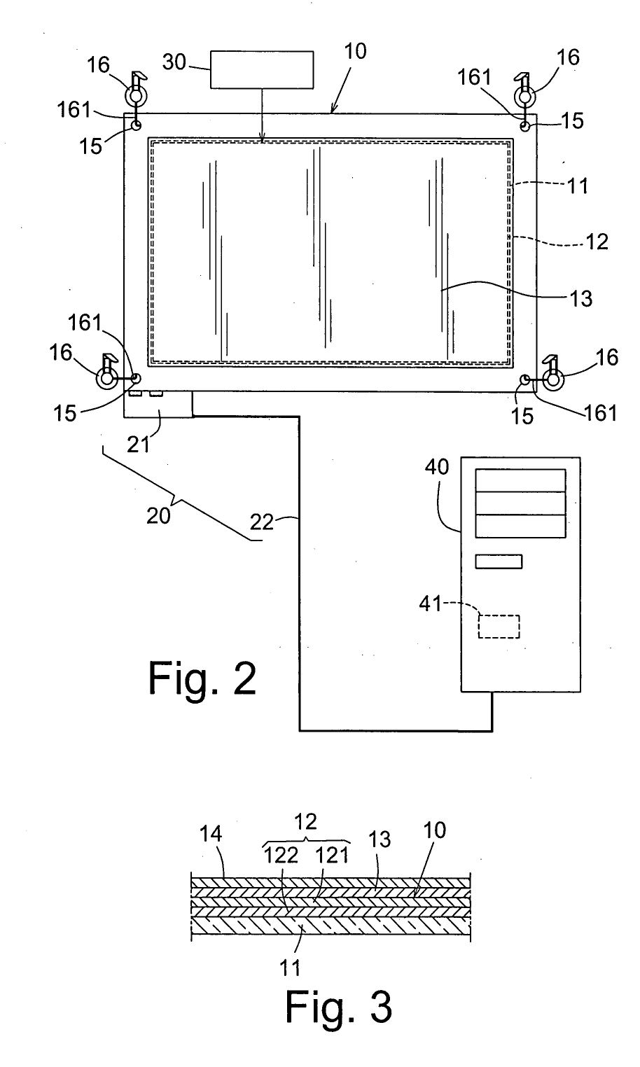

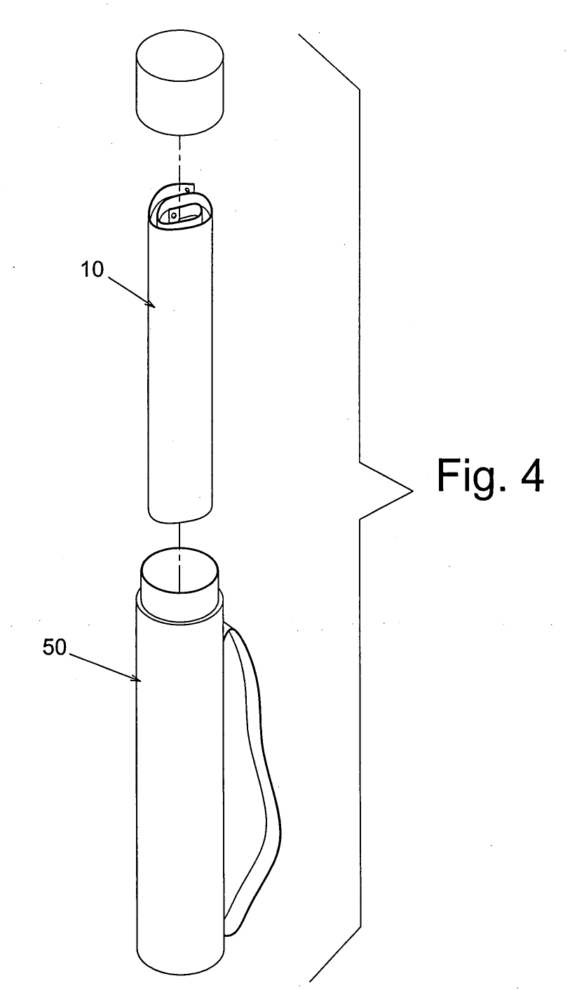

In use of the soft display system of the present invention, a user only needs to stretch the soft display panel 10 and plug the controller 20 with the soft display panel 10. Then the controller 20 is connected to the computer equipment 40. Thereafter, the user can use the input control device 30 such as his/her finger, an electronic pen or a wireless handwriting board to write characters or draft drawings. At this time, the display layer 13 of the soft display panel 10 will immediately show the same characters and drawings for demonstration or teaching as shown in FIG. 2. After used, the user can separate the soft display panel 10 from the controller 20 and roll the soft display panel 10 to store the same in a containing barrel 50. Accordingly, the user can easily carry the present invention with him/her and conveniently use the same as shown in FIG. 4.

According to the above arrangement, it is no more necessary to use a frame or a casing for fixing the soft display panel 10 of the present invention. Therefore, the soft display system of the present invention is lightweight. In addition, the soft display panel 10 can be made with different sizes as necessary to meet the requirements of different users. Moreover, after used, the soft display panel 10 can be rolled and stored in a containing barrel 50. Therefore, the user can easily carry the present invention with him/her and conveniently use the same.

The above embodiments are only used to illustrate the present invention, not intended to limit the scope thereof. Many modifications of the above embodiments can be made without departing from the spirit of the present invention.

What is claimed is:

1. A soft display system comprising:
(a) a soft display panel composed of a transparent substrate layer, a soft circuit layer and a display layer;
(b) a controller having a signal transmission device connected to the soft circuit layer;
(c) an input control device for generating signals corresponding characters and drawings; and
(d) a computer equipment having a computer application interface connected to the signal transmission device, the input control device serving to generate signals corresponding to the characters or drawings, which signals are processed by the computer equipment, by means of the conversion of the computer application interface, via the signal transmission device, the signals being output to the soft circuit layer, whereby the images of the characters or drawings are shown on the display layer of the soft display panel.

2. The soft display system as claimed in claim 1, wherein the soft display panel further has a protective layer overlaid on outer side of the display layer.

3. The soft display system as claimed in claim 1, wherein the soft circuit layer of the soft display panel includes a receiving circuit and a display circuit, the receiving circuit serving to responsively receive the signals generated by the input control device, the display circuit serving to correspondingly show the images on the display layer, which images correspond to the signals transmitted from the signal transmission device.

4. The soft display system as claimed in claim 3, wherein the receiving circuit of the soft circuit layer is a touch control receiving circuit.

5. The soft display system as claimed in claim. 3, wherein the receiving circuit of the soft circuit layer is a wireless receiving circuit for correspondingly receiving wireless signals transmitted from the input control device.

6. The soft display system as claimed in claim 1, wherein the soft display panel is equipped with hanging sections for hanging the soft display panel on a wall.

7. The soft display system as claimed in claim 1, wherein the signal transmission device of the controller is connected to the computer equipment via a signal transmission cable.

8. The soft display system as claimed in claim 1, wherein the signal transmission device of the controller is bi-directionally connected to the computer equipment via a wireless element.

9. A soft display system comprising:
(a) a soft display panel composed of a transparent substrate layer, a soft circuit layer and a display layer;
(b) a controller having a signal transmission device connected to the soft circuit layer; and
(c) a computer equipment having a computer application interface connected to the signal transmission device, by means of the conversion of the computer application interface, via the signal transmission device, the computer equipment serving to output signals to the soft circuit layer, whereby the images of the characters or drawings are shown on the display layer of the soft soft display panel.

10. The soft display system as claimed in claim 9, the signal transmission device of the controller is connected to the computer equipment via a signal transmission cable.

11. The soft display system as claimed in claim 9, wherein the signal transmission device of the controller is bi-directionally connected to the computer equipment via a wireless element.
